(19) United States
(12) Patent Application Publication
(10) Pub. No.: US 2013/0278621 A1
(43) Pub. Date: Oct. 24, 2013

(54) DISPLAY CONTROL APPARATUS AND DISPLAY SYSTEM

(71) Applicant: SONY CORPORATION, Tokyo (JP)

(72) Inventor: Akihito Nishiike, Kanagawa (US)

(73) Assignee: SONY CORPORATION, Tokyo (JP)

(21) Appl. No.: 13/827,399

(22) Filed: Mar. 14, 2013

(30) Foreign Application Priority Data
Apr. 18, 2012 (JP) 2012-094465

(51) Int. Cl. G06T 11/00

(52) U.S. Cl. CPC G06T 11/001
USPC 345/589

(57) ABSTRACT

To a display control apparatus, a plurality of display apparatuses each having a unique identification code are capable of being connected. The display control apparatus distinguishes the display apparatus for a monochrome display and the display apparatus for a color display from each other with the identification codes when the display apparatuses are connected thereto. The display control apparatus performs a control process for generating a monochrome signal when the display apparatus for the monochrome display is identified, and performs a control process for generating a color signal when the display apparatus for the color display is identified.

### BACKGROUND

The present disclosure relates to a display control apparatus and a display system. Specifically, the present disclosure relates to a technology for causing functions of a display apparatus to be appropriately operated by identifying the display apparatus with an identification code when the display apparatus is connected and performing a control process for generating a monochrome signal or a color signal on the basis of an identification result.

As an apparatus used as a display apparatus that displays an image on a display unit such as an organic EL (electro luminescence) display and a liquid crystal display, there are a television receiver, a personal computer, a display device, a mobile phone, a tablet terminal, and the like.

In particular, these days, display apparatuses such as an electronic book are becoming popular in which information including a book content is input and which is capable of displaying the input information on a display screen.

There are known a display control apparatus that functions as an information input apparatus capable of inputting various pieces of information to such various display apparatuses and a display system provided therewith (see, FIG. 3 and the like of Japanese Patent Application Laid-open No. 2001-66999).

To the display system disclosed in Japanese Patent Application Laid-open No. 2001-66999, an ID control unit is provided in an information processing unit that functions as the display control apparatus, and a setting holding unit in which an identification (ID) is stored is provided to a display unit that functions as a display apparatus. In the setting holding unit, the size of a display screen, a document name, a write date, secret information, link information, and the like are stored.

If the display apparatus is connected to the display control apparatus, an ID control signal is sent from the setting holding unit by the ID control unit, and the information stored in the setting holding unit is read. When the information is read by the ID control unit, the size of the display screen and the like of the display apparatus connected to the display control apparatus are detected.

### SUMMARY

Incidentally, in recent years, display apparatuses such as electronic books which are capable of displaying monochrome images and also color images have been developed. In a display apparatus that is capable of displaying color images, it is desirable that the color images relating to information input from a display control apparatus to the display apparatus are displayed.

In the display control apparatus and the display system disclosed in Japanese Patent Application Laid-open No. 2001-66999, however, information relating to the color of an image to be displayed is not set, and only monochrome images are displayed in the display apparatus that is capable of displaying color images.

Accordingly, there is a problem in that displaying appropriate to the display apparatus is not performed, and the functions of the display apparatus is difficult to be exerted.

In view of the above-mentioned circumstances, it is desirable that the problem is overcome, and the functions of the display apparatus are caused to be appropriately exerted.

First, according to an embodiment of the present disclosure, there is provided a display control apparatus, to which a plurality of display apparatuses each having a unique identification code are capable of being connected. The display control apparatus distinguishes the display apparatus for a monochrome display and the display apparatus for a color display from each other with the identification codes when the display apparatuses are connected thereto. The display control apparatus performs a control process for generating a monochrome signal when the display apparatus for the monochrome display is identified, and performs a control process for generating a color signal when the display apparatus for the color display is identified.

Therefore, in the display control apparatus, the process for displaying the monochrome image on the display apparatus when the display apparatus for the monochrome display is identified, and the process for displaying the color image on the display apparatus when the display apparatus for the color display is identified.

Second, in the display control apparatus, it is desirable that, when the display apparatus for the color display is identified, control for converting a color pattern arrangement is capable of being performed in accordance with a color pattern arrangement in pixels of the display apparatus identified.

When the display apparatus for the color display is identified, by making it possible to perform the control for converting the color pattern arrangement in accordance with the color pattern arrangement in the pixels of the display apparatus identified, an arrangement corresponding to the color pattern arrangement held in advance by the display apparatuses is performed.

Third, in the display control apparatus, it is desirable that, when the display apparatus for the color display is identified, control is performed to display a monochrome image in a predetermined area on a display screen of the display apparatus and display a color image in an area outside the predetermined area.

When the display apparatus for the color display is identified, by performing control so that the monochrome image is displayed in the predetermined area on the display screen of the display apparatus, and the color image is displayed in the area outside the predetermined area, it is possible to display the color image and the monochrome image on the same screen.

Fourth, in the display control apparatus, it is desirable that, when one of the display apparatus for the monochrome display and the display apparatus for the color display is identified, an image including user setting information set by a user is capable of being displayed in the display apparatus.

When the display apparatus for the monochrome display or the display apparatus for the color display is identified, in the display apparatus, by making it possible to display the image including the user setting information set by the user, the image including the user setting information set by the user is displayed.

Fifth, in the display control apparatus, it is desirable that, when one of the display apparatus for the monochrome display and the display apparatus for the color display is identified, an image based on image quality adjusted is capable of being displayed in the display apparatus.

When the display apparatus for the monochrome display or the display apparatus for the color display is identified, in the display apparatus, by making it possible to display the image based on the image quality adjusted, the image based on the image quality adjusted is displayed in the display apparatuses.

According to another embodiment of the present disclosure, there is provided a display system including a plurality of display apparatuses each having a unique identification code and a display control apparatus to which the plurality of display apparatuses are capable of being connected. In the display system, the display control apparatus distinguishes the display apparatus for a monochrome display and the display apparatus for a color display from each other with the identification codes when the display apparatuses are connected thereto. The display control apparatus performs a control process for generating a monochrome signal when the display apparatus for the monochrome display is identified, and performs a control process for generating a color signal when the display apparatus for the color display is identified.

Thus, in the display system, when the display control apparatus identifies the display apparatus for the monochrome display, the process for displaying the monochrome image on the display apparatus is performed, when the display control apparatus identifies the display apparatus for the color display, the process for displaying the color image on the display apparatus is performed.

To the display control apparatus according to the embodiment of the present disclosure, a plurality of display apparatuses each having a unique identification code are capable of being connected. The display control apparatus distinguishes the display apparatus for a monochrome display and the display apparatus for a color display from each other with the identification codes when the display apparatuses are connected thereto. The display control apparatus performs a control process for generating a monochrome signal when the display apparatus for the monochrome display is identified, and performs a control process for generating a color signal when the display apparatus for the color display is identified.

As a result, display appropriate to the display apparatuses is performed, and it is possible to appropriately exert the functions of the display apparatuses.

In the display control apparatus, when the display apparatus for the color display is identified, control for converting a color pattern arrangement is capable of being performed in accordance with a color pattern arrangement in pixels of the display apparatus identified.

Therefore, the arrangement corresponding to the color pattern arrangement held in advance by the display apparatuses is performed, so it is possible to improve general versatility and improve usability.

In the display control apparatus, when the display apparatus for the color display is identified, control is performed to display a monochrome image in a predetermined area on a display screen of the display apparatus and display a color image in an area outside the predetermined area.

Therefore, the color image and the monochrome image are displayed on the same screen, so it is possible to improve the usability by improving the functionality.

In the display control apparatus, when one of the display apparatus for the monochrome display and the display apparatus for the color display is identified, an image including user setting information set by a user is capable of being displayed in the display apparatus.

Therefore, the image including the user setting information set by the user is displayed, and it is possible to ensure high functionality of the display apparatus.

In the display control apparatus, when one of the display apparatus for the monochrome display and the display apparatus for the color display is identified, an image based on image quality adjusted is capable of being displayed in the display apparatus.

Therefore, it is possible to improve the quality of images displayed on the display apparatuses.

The display system includes a plurality of display apparatuses each having a unique identification code, and a display control apparatus to which the plurality of display apparatuses are capable of being connected. In the display system, the display control apparatus distinguishes the display apparatus for a monochrome display and the display apparatus for a color display from each other with the identification codes when the display apparatuses are connected thereto, and the display control apparatus performs a control process for generating a monochrome signal when the display apparatus for the monochrome display is identified, and performs a control process for generating a color signal when the display apparatus for the color display is identified.

Therefore, the display appropriate to the display apparatuses is performed, and it is possible to appropriately exert the functions of the display apparatuses.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a schematic structural diagram of a display system, which shows a best mode of the present disclosure along with FIGS. 2 to 9;

FIG. 2 is as diagram showing a state in which the content of information of a display apparatus is rewritten;

FIG. 3 is a block diagram showing a display control apparatus and the display apparatus;

FIG. 4 is a diagram showing an example of information which is stored in an ID storage memory of the display apparatus;

FIG. 5 is a schematic diagram showing an arrangement state of pixels;

FIG. 6 is a schematic diagram showing another example of an arrangement state of pixels;

FIG. 7 is a flowchart showing an operation of the display control apparatus;

FIG. 8 is a diagram showing an example of a display apparatus in which a monochrome image and a color image are displayed in different display areas; and

FIG. 9 is a schematic diagram showing an example of a display system in which image information is distributed from an image distribution unit.

### DETAILED DESCRIPTION OF EMBODIMENTS

Hereinafter, an embodiment of the present disclosure will be described with reference to the drawings.

In the embodiment to be described below, a display control apparatus of the present disclosure is applied to a display control apparatus that performs control for a display apparatus that has functions as a tablet terminal such as an electrical book, and a display system of the present disclosure is applied to a display system that has the display apparatus having the functions as the tablet terminal such as the electrical book and the display control apparatus that performs control for the electrical book.

It should be noted that the range of an application of the display control apparatus of the present disclosure is not limited to the display control apparatus that performs control for the display apparatus having the functions as the tablet terminal such as the electrical book. For example, the display control apparatus of the present disclosure can be widely applied to a display control apparatus that performs control for various display apparatuses such as a television receiver, a personal computer, a display apparatus, and a mobile phone.

Further, the range of an application of the display system of the present disclosure is not limited to the display system including the display apparatus having the functions as the tablet terminal such as the electrical book and the display control apparatus that performs control for the electrical book. For example, the display system of the present disclosure can be widely applied to a display system including a display apparatus such as a television receiver, a personal computer, a display apparatus, and a mobile phone and a display control apparatus that performs control for those various display apparatuses.

(Schematic Structure of Display System)

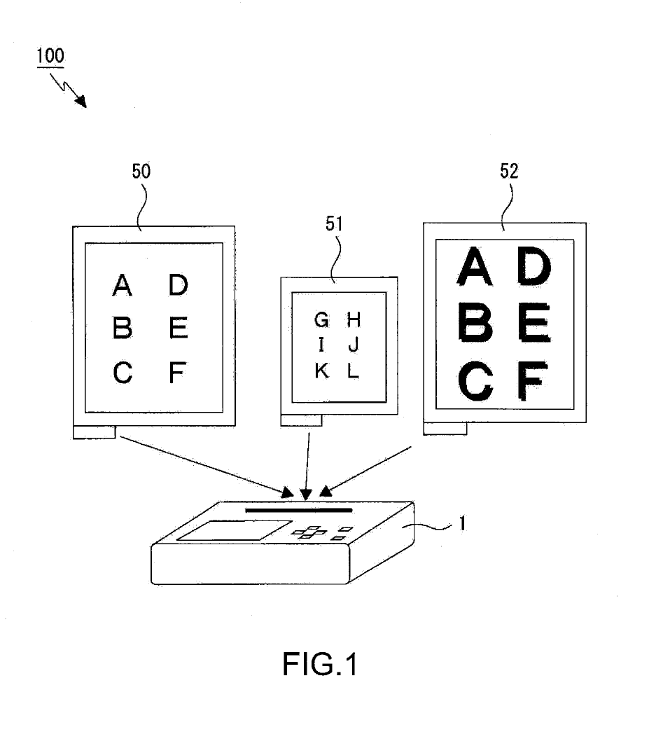

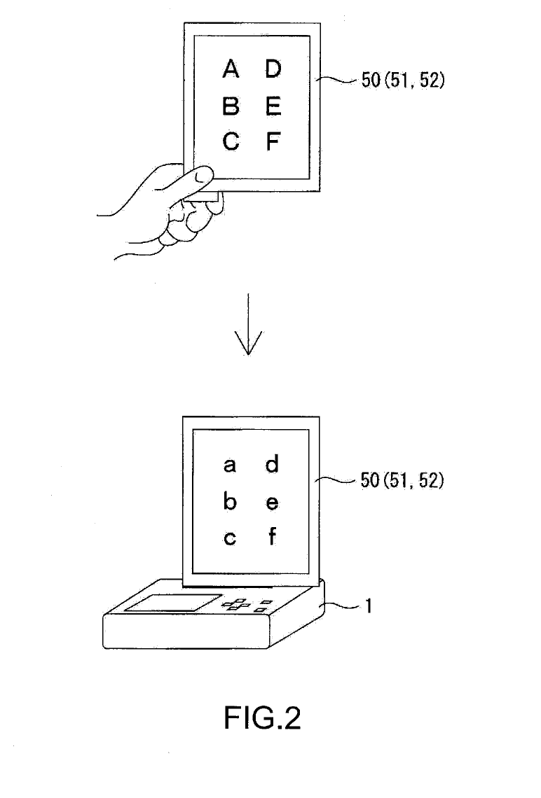

First, the schematic structure of the display system will be described (see, FIGS. 1 and 2).

The display system 100 is provided with a plurality of display apparatuses 50, 51, 52 . . . each having a unique identification code (ID) and a display control apparatus 1 to which the display apparatuses 50, 51, 52 . . . are capable of being connected (see, FIG. 1).

The display apparatuses 50, 51, 52 . . . are, for example, electrical books of a type of a monochrome display for displaying monochrome images or a type of a color display for displaying color images. It should be noted that the display apparatuses 50, 51, 52 . . . each may be capable of displaying a monochrome image and a color image in different display areas.

The display apparatuses 50, 51, 52 . . . each have a memory function. When a power switch is operated to shut down power, and then the power is activated again, an image displayed immediately before the power is shut down is displayed.

To the display control apparatus 1, an image memory to be described later is provided, and various pieces of information are input from an information input unit to the image memory and stored therein. The information input unit is an image pickup apparatus such as a digital camera, a scanner, a server or the like serving as a downloading source. The information to be input thereto is information such as image data or text data.

If the display apparatuses 50, 51, 52 . . . are connected to the display control apparatus 1, the information is input to the display apparatuses 50, 51, 52 . . . by the display control apparatus 1, and the information is added or rewritten with respect to the display apparatuses 50, 51, 52 . . . (see, FIG. 2). In addition, at this time, on the basis of the identification codes held by the display apparatuses, the display control apparatus 1 identifies each of the display apparatuses 50, 51, 52 . . . as one for a monochrome display or one for a color display.

(Structural Examples of Display Control Apparatus and Display Apparatus)

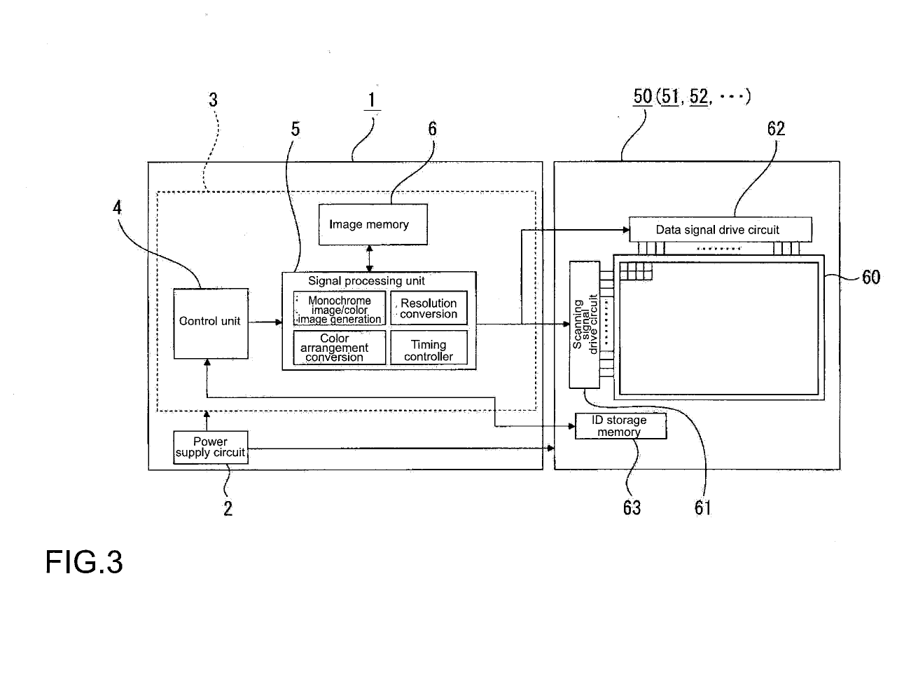

Next, structural examples of the display control apparatus and the display apparatus will be described (see, FIG. 3).

To the display control apparatus 1, a power supply circuit 2 and a drive circuit 3 are provided. To the drive circuit 3, power for drive is supplied from the power supply circuit 2. The power supply circuit 2 also has a function for supplying power for drive (for display) to the display apparatuses 50, 51, 52 . . . .

The drive circuit 3 has a control unit 4, a signal processing unit 5, and an image memory 6.

The control unit 4 has a function for performing overall control for the display control apparatus 1, and is a CPU (central processing unit), for example. With the control unit 4, which of the display apparatuses 50, 51, 52 . . . is connected to the display control apparatus 1 is identified.

The signal processing unit 5 is controlled by the control unit 4. The signal processing unit 5 performs various processing such as generation of a monochrome image and a color image, conversion of the resolution of an image, conversion of the color pattern arrangement of a color filter, and control of a timing controller.

In the image memory 6, various pieces of information such as image data and text data are stored, and the information stored in the image memory 6 is read by the signal processing unit 5.

The display apparatus 50 (51, 52, . . . ) is provided with a display unit 60. As the display unit 60, various displays such as an organic EL (electro luminescence) display, a liquid crystal display, and a plasma display are used.

On the display unit 60, a scanning signal and a data signal (image signal) are input from a scanning signal drive circuit 61 and a data signal drive circuit 62, and a predetermined image is displayed. The scanning signal drive circuit 61 and the data signal drive circuit 62 are controller by the signal processing unit 5 of the display control apparatus 1.

The display apparatuses 50, 51, 52 . . . each have an ID storage memory 63. In the ID storage memory 63, a unique identification code (ID) created for the display apparatus 50 (51, 52 . . . ) with 1 to several bits is stored.

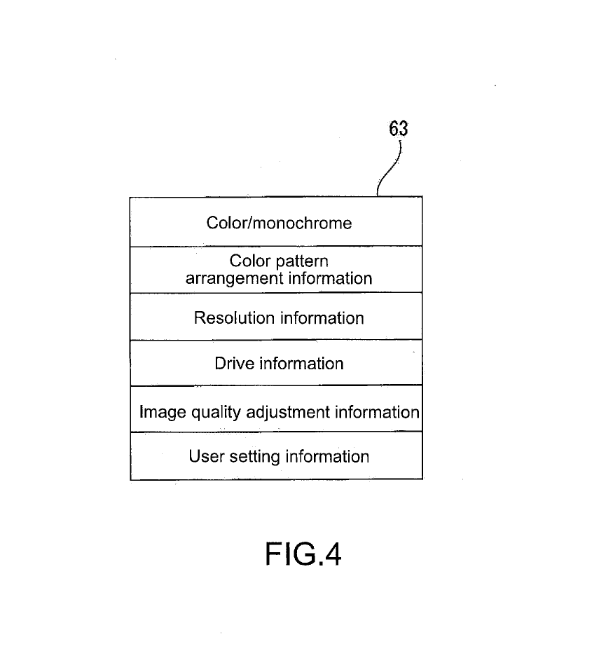

In the ID storage memory 63, for example, various pieces of information such as color and monochrome information, color pattern arrangement information, resolution information, drive information, image quality adjustment information, and user setting information are stored (see, FIG. 4).

The color and monochrome information is information for identifying each of the display apparatuses 50, 51, 52 . . . as a monochrome display type or a color display type.

The color pattern arrangement information is arrangement information of color filters held by each of the display apparatuses 50, 51, 52 . . . .

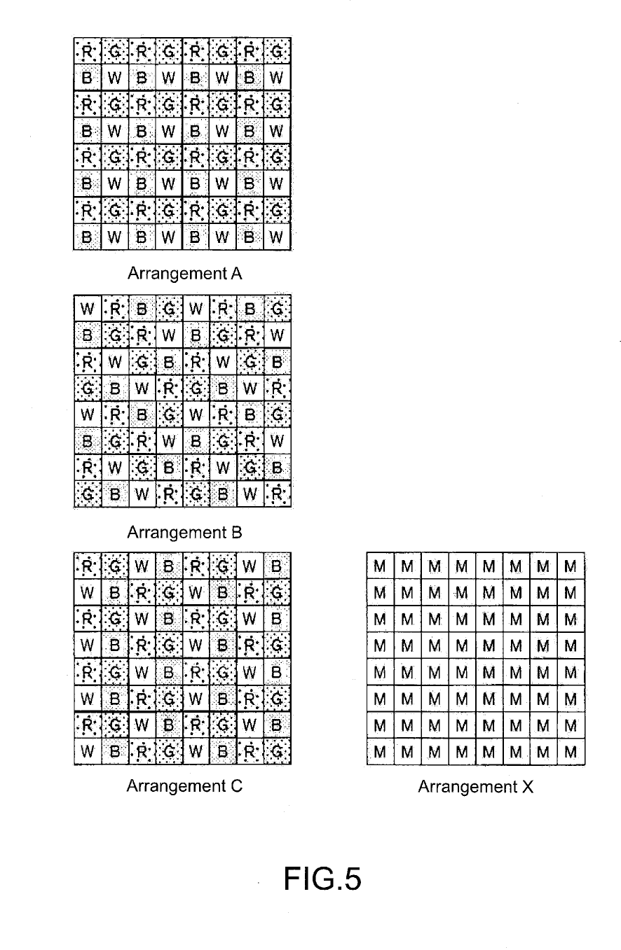

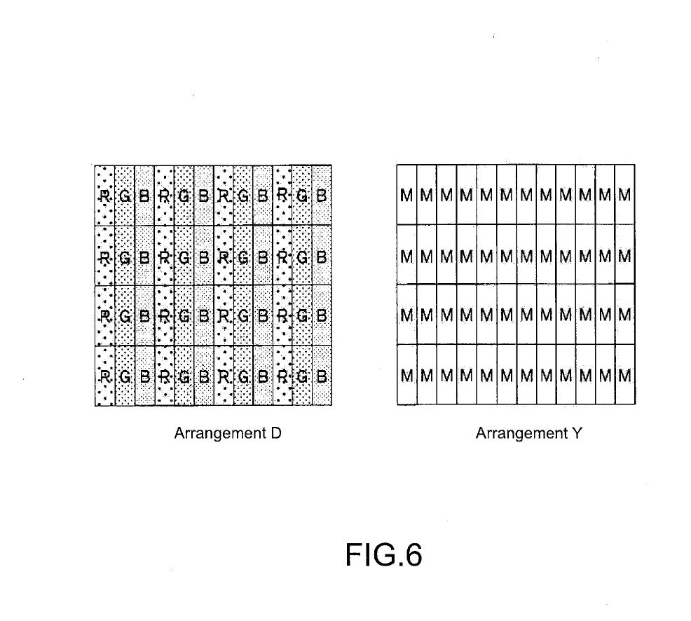

The color filter arrangement information is, for example, information relating to a structure of RGBW (red, green, blue, and white) (see, arrangement A, arrangement B, and arrangement C shown in FIG. 5) or a structure of RGB (red, green, and blue) of pixels (see, arrangement D of FIG. 6). Further, the color filter arrangement information is information of the order of arrangement in the pixels, for example, information relating to how RGBW are arranged (arrangement A, arrangement B, or arrangement C) in the case where the pixels have the structure of RGBW (see, FIG. 5).

In addition, the structure of the pixels is not limited to the RGB or the RGBW, and for example, CMY (cyan, magenta, and yellow), CMYW (cyan, magenta, yellow, and white), or the like may be used.

It should be noted that, in FIGS. 5 and 6, examples of the structure of the arrangement in the display apparatus for the monochrome display (arrangement X and arrangement Y) are shown in addition to the examples of the structure of the color pattern. Out of the display apparatuses 50, 51, 52 . . . , the display apparatus for the monochrome display has the arrangement for the monochrome such as the arrangement X or the arrangement Y.

The resolution information is information relating to the resolution of each of the display apparatuses 50, 51, 52 . . . .

The drive information is various pieces of information such as a drive frequency, timing characteristics, the size of a display screen, and the like of each of the display apparatuses 50, 51, 52 . . . .

The user setting information is various pieces of information input to each of the display apparatuses 50, 51, 52 . . . by a user. The user setting information includes the size of characters to be output as an image, the kind of characters, a document name, a write date and time, secret information, link information, information relating to an immediately preceding display content, information for causing immediately preceding content to be displayed after the power is activated, and the like.

(Operation of Display Control Apparatus)

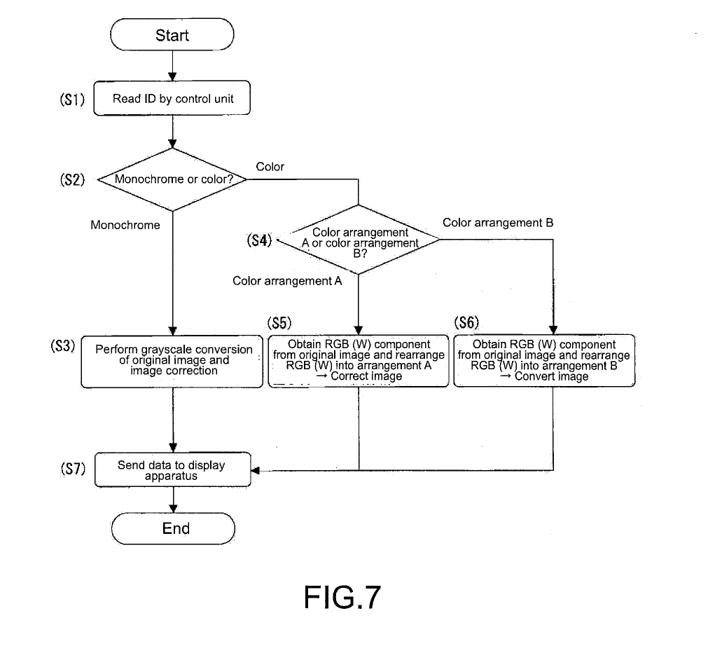

Next, the operation of the display control apparatus 1 will be described (see, FIG. 7).

S1: When the display apparatus 50 (51, 52 . . . ) is connected to the display control apparatus 1, an operation is started, and the control unit 4 reads a unique identification code (ID) stored in the ID storage memory 63 of the display apparatus 50 (51, 52 . . . ). When the control unit 4 reads the unique identification code of the display apparatus 50 (51, 52 . . . ), the control unit 4 identifies one of the display apparatuses 50, 51, 52 . . . as an apparatus that is connected to the display control apparatus 1.

S2: As a result of the identification by the control unit 4, if it is detected that the display apparatus for the monochrome display is connected to the display control apparatus 1, the process proceeds to S3, and if it is detected that the display apparatus for the color display is connected to the display control apparatus 1, the process proceeds to S4.

S3: The signal processing unit 5 obtains data of R, G, and B from an original image, performs a gray scale conversion process, and corrects an image to be displayed on the display apparatus 50 (51, 52 . . . ). For example, the data of R, G, and B for each pixel is obtained, and the gray scale conversion process of the following expression or the like is performed.

M=(I*R)+(J*G)+(K*B) (1)

where the RGB are respective data, and the IJK are coefficients. On the basis of M calculated from the expression, an image correction such as a gradation adjustment and an image quality adjustment is performed.

S4: In the case where the color pattern arrangement in the pixels of the display apparatus identified is the arrangement A (see, FIG. 5), the process proceeds to S5, and in the case where the color pattern arrangement is the arrangement B, the process proceeds to S6. It should be noted that in this operation, the example in which the two different arrangements of the arrangement A and the arrangement B are set is given, but the arrangement types are not limited to two, and three or more arrangement types may be set.

S5: The signal processing unit 5 obtains data of the R, G, and B from the original image. At this time, for example, in the case where W (white) exists in the pixels, a conversion process for generating data of W is performed, and an image to be displayed on the display apparatus 50 (51, 52 . . . ) is corrected. For example, data of R, G, and B for each pixel is obtained, and the conversion process of the following expression or the like is performed.

W=(R+G+B)/3 (2)

where RGB are respective data. The data of W calculated from the expression (2) and the data of R, G, and B are rearranged as in the arrangement A, and an image correction such as a gradation adjustment and an image quality adjustment in accordance with the display apparatus 50 (51, 52 . . . ) is performed. It should be noted that the data of R, G, B, and W may be obtained through calculation.

S6: The signal processing unit 5 obtains data of the R, G, and B from the original image. At this time, for example, in the case where W (white) exists in the pixels, a conversion process for generating data of W is performed, and an image to be displayed on the display apparatus 50 (51, 52 . . . ) is corrected. For example, data of R, G, and B for each pixel is obtained, and the conversion process of the following expression or the like is performed.

W=(R+G+B)/3 (2)

where RGB are respective data. The data of W calculated from the expression (2) and the data of R, G, and B are rearranged as in the arrangement B, and an image correction such as a gradation adjustment and an image quality adjustment in accordance with the display apparatus 50 (51, 52 . . . ) is performed. It should be noted that the data of R, G, B, and W may be obtained through calculation.

S7: The image data that has been subjected to the correction is transmitted to the display apparatus 50 (51, 52 . . . ). In the display apparatus 50 (51, 52 . . . ), on the basis of the image data input, the image corrected is displayed on the display unit 60, and the operation is terminated.

(Another Example)

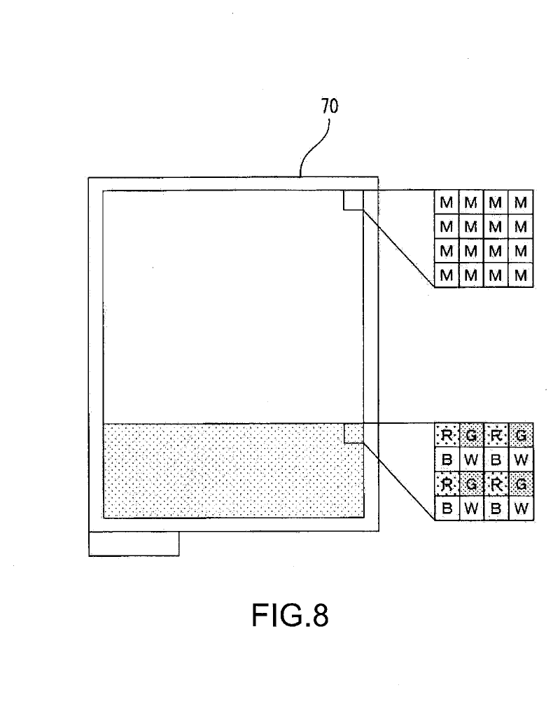

In the above, the example in which the display apparatuses 50, 51, 52 . . . for the monochrome display for displaying a monochrome image or for the color display for displaying a color image is given, but as shown in FIG. 8, a display apparatus 70 that displays a monochrome image and a color image in different display areas can be used, for example.

The display apparatus 70 is identified by the control unit 4 of the display control apparatus 1 as the display apparatus for the color display.

In this way, when the display apparatus 70 for the color display is identified, the monochrome image and the color image are displayed in the different display areas, with the result that the color image and the monochrome image are displayed on the same display screen, functionality is improved, and thus usability can be improved.

(Another Example of Display System)

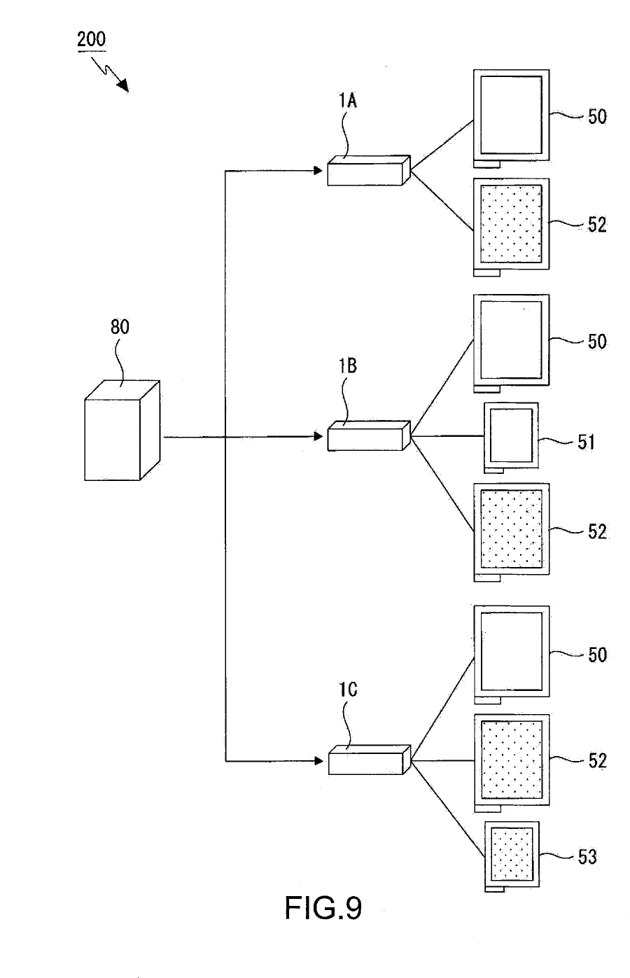

Hereinafter, another example of the display system will be described (see, FIG. 9).

A display system 200 has a plurality of display control apparatuses, for example, three display control apparatuses 1A, 1B, and 1C and the display apparatuses 50, 51, 52 . . . ). It should be noted that any numbers of display control apparatuses and display apparatuses may be used, as long as a plurality of display control apparatuses and a plurality of display apparatuses are used.

To the display control apparatuses 1A, 1B, and 1C, an image signal (image information) is distributed from an image distribution unit 80 through wired or wireless communication.

To the display control apparatuses 1A, 1B, and 1C, a plurality of display apparatuses 50, 51, 52, 53, . . . each having a unique identification code are connectable. The display apparatuses 50, 51, 52, 53, . . . are used for the monochrome display for displaying a monochrome image or the color display for displaying a color image. It should be noted that the display apparatuses 50, 51, 52, 53, . . . each may display a monochrome image and a color image in different display areas, respectively.

As described above, in the display system 200 in which the image signal is distributed from the image distribution unit 80 to the display control apparatuses 1A, 1B, and 1C, information distributed from the image distribution unit 80 is displayed on the display apparatuses 50, 51, 52, 53, . . . as the monochrome image or the color image.

(Conclusion)

As described above, in the display control apparatuses 1A, 1B, and 1C, the display apparatus for the monochrome display and the display apparatus for the color display are distinguished with the use of the identification codes, the control process for generating the monochrome signal is performed when the display apparatus for the monochrome display is identified, and the control process for generating the color signal is performed when the display apparatus for the color display is identified.

Therefore, the display is performed so as to be appropriate to the display apparatuses 50, 51, 52, . . . , and the functions held by the display apparatuses 50, 51, 52, . . . can be exerted.

Furthermore, if the user does not perform setting of the monochrome image display or the color image display, an image is automatically displayed in accordance with a specification of the display apparatus, with the result that the usability can be improved.

In addition, when the display apparatus for the color display is identified, it is possible to perform conversion control of the color pattern arrangement in accordance with the color pattern arrangement in the pixels of the display apparatus identified.

Thus, the arrangement corresponding to the color pattern arrangement held in advance by the display apparatuses 50, 51, 52, . . . , so it is possible to improve the general versatility and the usability.

It should be noted that in the display control apparatuses 1, 1A, 1B, and 1C, when the display apparatus for the monochrome display and the display apparatus for the color pattern arrangement are distinguished, it is also possible to display an image including user setting information which is determined by the user in the display apparatuses 50, 51, 52, . . . .

By displaying the image including the user setting information which is determined by the user as described above, it is possible to ensure high functionalities of the display apparatuses 50, 51, 52, . . . .

Further, when the display apparatus for the monochrome display and the display apparatus for the color pattern arrangement are distinguished, it is also possible to display an image based on image quality adjusted in the display apparatuses 50, 51, 52, . . . .

By displaying the image based on the image quality adjusted in the display apparatuses 50, 51, 52, . . . as described above, it is possible to increase the quality of images displayed on the display apparatuses 50, 51, 52, . . . .

(Present Technology)

It should be noted that the present disclosure can take the following configurations.

(1) A display control apparatus,

to which a plurality of display apparatuses each having a unique identification code are capable of being connected,

the display control apparatus distinguishing the display apparatus for a monochrome display and the display apparatus for a color display from each other with the identification codes when the display apparatuses are connected thereto,

the display control apparatus performing a control process for generating a monochrome signal when the display apparatus for the monochrome display is identified, and performing a control process for generating a color signal when the display apparatus for the color display is identified.

(2) The display control apparatus according to Item (1), in which

when the display apparatus for the color display is identified, control for converting a color pattern arrangement is capable of being performed in accordance with a color pattern arrangement in pixels of the display apparatus identified.

(3) The display control apparatus according to Item (1) or (2), in which

when the display apparatus for the color display is identified, control is performed to display a monochrome image in a predetermined area on a display screen of the display apparatus and display a color image in an area outside the predetermined area.

(4) The display control apparatus according to any one of Items (1) to (3), in which

when one of the display apparatus for the monochrome display and the display apparatus for the color display is identified, an image including user setting information set by a user is capable of being displayed in the display apparatus.

(5) The display control apparatus according to any one of Items (1) to (4), in which

when one of the display apparatus for the monochrome display and the display apparatus for the color display is identified, an image based on image quality adjusted is capable of being displayed in the display apparatus.

(6) A display system, including:

a plurality of display apparatuses each having a unique identification code; and

a display control apparatus to which the plurality of display apparatuses are capable of being connected, in which

the display control apparatus distinguishes the display apparatus for a monochrome display and the display apparatus for a color display from each other with the identification codes when the display apparatuses are connected thereto, and

the display control apparatus performs a control process for generating a monochrome signal when the display apparatus for the monochrome display is identified, and performs a control process for generating a color signal when the display apparatus for the color display is identified.

The present disclosure contains subject matter related to that disclosed in Japanese Priority Patent Application JP 2012-094465 filed in the Japan Patent Office on Apr. 18, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus,
to which a plurality of display apparatuses each having a unique identification code are capable of being connected,
the display control apparatus distinguishing the display apparatus for a monochrome display and the display apparatus for a color display from each other with the identification codes when the display apparatuses are connected thereto,
the display control apparatus performing a control process for generating a monochrome signal when the display apparatus for the monochrome display is identified, and performing a control process for generating a color signal when the display apparatus for the color display is identified.

2. The display control apparatus according to claim 1, wherein
when the display apparatus for the color display is identified, control for converting a color pattern arrangement is capable of being performed in accordance with a color pattern arrangement in pixels of the display apparatus identified.

3. The display control apparatus according to claim 1, wherein
when the display apparatus for the color display is identified, control is performed to display a monochrome image in a predetermined area on a display screen of the display apparatus and display a color image in an area outside the predetermined area.

4. The display control apparatus according to claim 1, wherein
when one of the display apparatus for the monochrome display and the display apparatus for the color display is identified, an image including user setting information set by a user is capable of being displayed in the display apparatus.

5. The display control apparatus according to claim 1, wherein
when one of the display apparatus for the monochrome display and the display apparatus for the color display is identified, an image based on image quality adjusted is capable of being displayed in the display apparatus.

6. A display system, comprising:
a plurality of display apparatuses each having a unique identification code; and
a display control apparatus to which the plurality of display apparatuses are capable of being connected, wherein
the display control apparatus distinguishes the display apparatus for a monochrome display and the display apparatus for a color display from each other with the identification codes when the display apparatuses are connected thereto, and
the display control apparatus performs a control process for generating a monochrome signal when the display apparatus for the monochrome display is identified, and performs a control process for generating a color signal when the display apparatus for the color display is identified.
